(19) United States
(12) Patent Application Publication
(10) Pub. No.: US 2025/0247477 A1
(43) Pub. Date: Jul. 31, 2025

(54) DEVICE FOR SETTING REGION IN IMAGE PROCESSING APPARATUS, CONTROL METHOD FOR DEVICE, AND STORAGE MEDIUM

(71) Applicant: CANON KABUSHIKI KAISHA, Tokyo (JP)

(72) Inventor: AKIHIRO MORIYA, Chiba (JP)

(21) Appl. No.: 19/026,904

(22) Filed: Jan. 17, 2025

(30) Foreign Application Priority Data
Jan. 25, 2024 (JP) 2024-009297

(51) Int. Cl. H04N 1/00; H04N 1/32; H04N 1/44

(52) U.S. Cl. CPC H04N 1/00344; H04N 1/00244; H04N 1/32101; H04N 1/4426; H04N 2201/0094; H04N 2201/3205

(57) ABSTRACT

A device that can adapt a region setting in an image processing apparatus to a status of service subscription. An information request to which identification information for identifying an image processing apparatus and region information including a region set in the image processing apparatus are assigned is transmitted to a management server. Search information is received from the management server as a response to the information request. The search information includes a result of searching performed using the identification information as to whether or not subscription information for a service regarding the image processing apparatus exists in a region server arranged in another region different from the region included in the region information.

### BACKGROUND OF THE INVENTION

### Field of the Invention

The present invention relates to a device, a control method for device, and a storage medium.

### Description of the Related Art

In an image processing apparatus such as an information output apparatus used in a word processor, a personal computer, a facsimile, or the like, an electrophotographic method and an inkjet method are widely used as methods for forming information such as an image on a sheet-like recording medium. In the image processing apparatus using such methods, a developer such as toner or ink is used to form information such as an image on a recording medium. Therefore, a user needs to purchase and replace a cartridge or developing device that contains a developer, or a process cartridge in which a charging device, a photosensitive drum, and a developing device are integrated as a consumable as necessary.

Therefore, a system for automatically ordering a consumable to a predetermined order destination has been provided in order to reduce user's labor related to the purchase of the consumable. In such a system, the image processing apparatus is used as a client apparatus, and a resource server automatically places an order based on information transmitted from the client apparatus. For this purpose, the user first subscribes to an automatic ordering service. Then, the client apparatus is registered in the resource server that manages the automatic ordering service. Thereafter, when the user performs printing by using the client apparatus, consumables information is transmitted from the client apparatus to the resource server. As a result, the resource server can automatically place an order for the user based on the consumables information transmitted from the client apparatus.

Meanwhile, in recent years, a law that defines a physical country or region (hereinafter, referred to as a “region”) has been established for the client apparatus that transmits data and the resource server that receives data from the viewpoint of protecting personal information and confidential information. As a result, since the number of regions of the resource server tends to increase year by year, it is assumed that the automatic ordering service is used in a large number of regions. Therefore, Japanese Laid-Open Patent Publication (kokai) No. 2019-61580 discloses a technology for specifying a uniform resource locator (URL) of an appropriate endpoint for region information designated by the client apparatus.

However, as described above, the specification of the URL of the endpoint depends on the region information designated by the client apparatus. Therefore, in a case where the user erroneously designates the region in the client apparatus, there is a possibility that the client apparatus is connected to the resource server of an erroneous endpoint. As a result, there is a problem that the user cannot correctly receive the automatic ordering service when the client apparatus is connected to the resource server arranged in a place different from the country or region where the user lives.

### SUMMARY OF THE INVENTION

The present invention provides a device, a control method for device, and a program that can adapt a region setting in an image processing apparatus to a status of service subscription.

According to an aspect of the invention, the present invention provides a device comprising a transmission unit configured to transmit, to a management server, an information request to which identification information for identifying an image processing apparatus and region information including a region set in the image processing apparatus are assigned, and a reception unit configured to receive search information from the management server as a response to the information request, wherein the search information includes a result of searching performed using the identification information as to whether or not subscription information for a service regarding the image processing apparatus exists in a region server arranged in another region different from the region included in the region information.

According to the present invention, the region setting in the image processing apparatus can be adapted to a status of service subscription.

Further features of the present invention will become apparent from the following description of exemplary embodiments (with reference to the attached drawings).

### BRIEF DESCRIPTION OF THE DRAWINGS

FIGS. 1A and 1B are diagrams showing a hardware configuration of a multifunction peripheral (MFP) and hardware configurations of various servers and a personal computer (PC).

FIG. 2 is a diagram showing a software configuration of the MFP.

FIGS. 3A to 3G are diagrams showing software configurations of various servers and the PC.

FIG. 4 is a diagram showing a network configuration of a system.

FIGS. 5A and 5B are views showing examples of screens for device registration displayed on an operation unit of the MFP.

FIG. 6 is a view showing an example of a region setting screen displayed

on the operation unit of the MFP.

FIG. 7 is a diagram for describing a relationship between a region and an endpoint.

FIGS. 8A and 8B are diagrams showing communication sequences among the MFP and various servers according to a first embodiment.

FIG. 9 is a diagram showing a periodic acquisition sequence.

FIG. 10 is a flowchart in a case where a region setting is changed on the region setting screen in the MFP.

FIGS. 11A to 11C are views showing update screens displayed on the operation unit of the MFP in a case where the region setting is changed.

FIG. 12 is a flowchart of connection destination information determination processing.

FIG. 13 is a view showing a change notification screen displayed on the operation unit of the MFP.

FIG. 14 is a view showing a home screen displayed on the operation unit of the MFP in a case where it is confirmed that the region is different in the periodic acquisition sequence of FIG. 9.

FIGS. 15A and 15B are diagrams showing communication sequences among an MFP, various servers, and a PC according to a second embodiment.

FIG. 16 is a view showing an example of an application setting screen displayed on the PC.

FIG. 17 is a view showing an example of a report setting screen displayed on the PC.

### DESCRIPTION OF THE EMBODIMENTS

Hereinafter, embodiments of the present invention will be described in detail with reference to the drawings. However, configurations described in the following embodiments are merely examples, and the scope of the present invention is not limited by the configurations described in the embodiments. For example, not all combinations of features described in the embodiments are essential to the solution of the invention. Further, each part in the present invention can be replaced with a part having any configuration capable of exhibiting similar functions. In addition, an arbitrary component may be added. Any two or more configurations (features) of the embodiments may be combined. In the embodiments, a multifunction peripheral (hereinafter, referred to as “MFP”) (device) having a reading function, a printing function, and the like will be described as an example of an image processing apparatus.

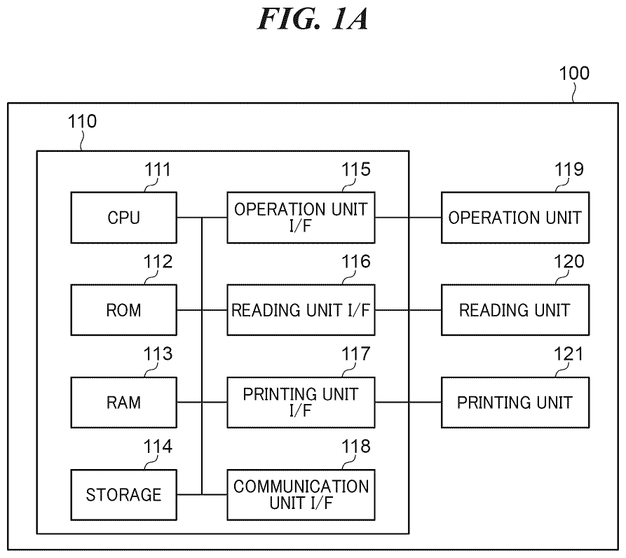

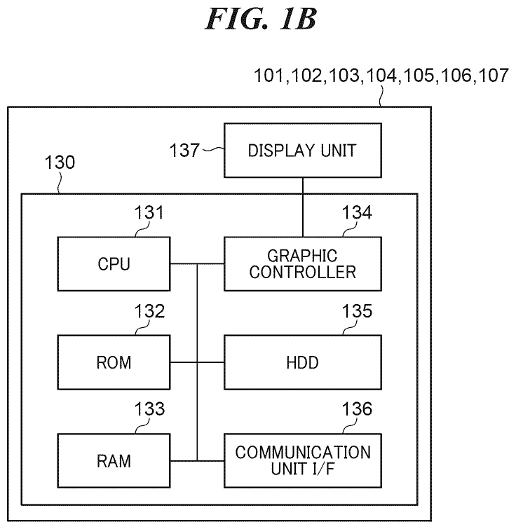

Hereinafter, a first embodiment will be described with reference to FIGS. 1A to 14. It should be noted that, in the following description, an interface may be referred to as an “I/F”. The same applies to a second embodiment described below. FIGS. 1A and 1B are diagrams showing a hardware configuration of an MFP 100 and hardware configurations of various servers 101 to 106 and a personal computer (PC) 107. It should be noted that, although an image processing system including the MFP 100, the various servers 101 to 106, and the PC 107 is exemplified in the first embodiment, the present technology is not limited thereto. First, the hardware configuration of the MFP 100 will be described with reference to FIG. 1A.

The MFP 100 has a reading function of reading an image on a sheet, a printing function of printing an image on a sheet, and the like. In addition, the MFP 100 has, for example, a file transmission function of transmitting image data to an external apparatus. It should be noted that, although the MFP 100 is described as an example of the image processing apparatus in the first embodiment, the present technology is not limited thereto. For example, the image processing apparatus may be a printing apparatus such as a printer having no reading function. The image processing apparatus may be an image reading apparatus such as a scanner having no printing function.

As shown in FIG. 1A, the MFP 100 includes a control unit 110. The control unit 110 includes a central processing unit (CPU) 111 and controls an operation of the entire MFP 100. In addition to the CPU 111, the control unit 110 includes a read only memory (ROM) 112, a random access memory (RAM) 113, a storage 114, an operation unit I/F 115, a reading unit I/F 116, a printing unit I/F 117, and a communication unit I/F 118. The CPU 111, the ROM 112, the RAM 113, the storage 114, the operation unit I/F 115, the reading unit I/F 116, the printing unit I/F 117, and the communication unit I/F 118 are communicably connected to one another via a bus. The CPU 111 reads various programs stored in the ROM 112 or the storage 114 into the RAM 113, and performs various controls such as reading control and printing control.

The ROM 112 stores a program executable by the CPU 111. The RAM 113 is a main storage memory of the CPU 111, and is used as a temporary storage area for loading various programs stored in the ROM 112 or the storage 114. The storage 114 stores print data, image data, various programs, and various setting information. It should be noted that, in the MFP 100, one CPU 111 uses one memory (RAM 113) to execute each processing shown in a flowchart and the like described below, but other execution forms may be used. For example, in the MFP 100, each processing shown in a flowchart and the like described below can be executed by cooperation of a plurality of CPUs, RAMs, ROMs, and storages. In addition, some processing may be executed by a hardware circuit such as an application specific integrated circuit (ASIC) or a field-programmable gate array (FPGA).

The operation unit I/F 115 connects an operation unit 119 and the control unit 110 to each other. The operation unit 119 is, for example, a touch panel. The reading unit I/F 116 connects the reading unit 120 and the control unit 110. The reading unit 120 reads an image on a sheet and generates image data. The image data generated by the reading unit 120 is transmitted to the external apparatus or printed on a sheet. The reading unit 120 can also read a plurality of sheets of documents by skimming sheets placed on a document feeder (not shown). The printing unit I/F 117 connects a printing unit 121 and the control unit 110. The image data to be printed is transferred from the control unit 110 to the printing unit 121 via the printing unit I/F 117.

The printing unit 121 receives a control command and the image data to be printed via the control unit 110, and prints an image based on the image data on a sheet. It should be noted that a printing method of the printing unit 121 may be an electrophotographic method or an inkjet method. In the electrophotographic method, an electrostatic latent image is formed on a photosensitive body and then developed with toner, and the toner image is transferred to the sheet and fixed to form the image. On the other hand, in the inkjet method, the image is printed on the sheet with ejected ink.

A consumable used for printing, such as a toner cartridge or an ink cartridge used in the printing unit 121, is detachably mounted inside the MFP 100. A user can perform consumable replenishment by replacing the cartridge. It should be noted that the CPU 111 acquires a remaining amount of the consumable necessary for printing at a regular timing, a timing of printing one page of an image, a timing of mounting the cartridge, or the like, and holds an acquired remaining amount of toner or the like in the RAM 113. In addition, the CPU 111 stores a model number of the cartridge in the RAM 113 or the storage 114 when mounting the cartridge.

Furthermore, the control unit 110 is connected to a network via the communication unit I/F 118. As a result, the control unit 110 can receive the print data and information and transmit information regarding the consumable, such as the remaining amount of the toner or the model number of the cartridge, stored in the RAM 113 or the storage 114, via the network. The print data received via the communication unit I/F 118 is analyzed by a software module (a page description language (PDL) analysis unit (not shown)) for analyzing the print data, the software module being stored in the storage 114 or the ROM 112. The PDL analysis unit generates data to be printed by the printing unit 121 based on the print data expressed in various types of page description languages.

Next, the hardware configurations of the various servers 101 to 106 and the PC 107 will be described with reference to FIG. 1B. As shown in FIG. 1B, the hardware configurations of the various servers 101 to 106 and the PC 107 are the same, the server 101 will be described below as an example. The server 101 includes a control unit 130. The control unit 130 includes a CPU 131, a ROM 132, a RAM 133, a graphic controller 134, a hard disk drive (HDD) 135, and a communication unit I/F 136. The CPU 131, the ROM 132, the RAM 133, the graphic controller 134, the HDD 135, and the communication unit I/F 136 are communicably connected to one another via a bus.

The CPU 131 includes an arithmetic circuit and integrally controls the server 101. The CPU 131 reads various programs stored in the ROM 132 or the

HDD 135 into the RAM 133, and executes various types of processing. The ROM 132 stores a system program and the like used for controlling the server 101. The graphic controller 134 generates a screen to be displayed on a display unit 137. The HDD 135 has a function as a storage area. The HDD 135 stores application programs and the like for executing various types of processing. The HDD 135 is an example of a storage device, and can be implemented by a solid state drive (SSD) or the like in addition to the HDD. The communication unit I/F 136 is for connecting various devices to the server 101. The communication unit I/F 136 connects, for example, a touch panel, a keyboard, a mouse, or the like to the server 101. In addition, the communication unit I/F 136 performs communication between the server 101 and the MFP 100 or the like via a network under the control of the CPU 131.

It should be noted that, hereinafter, the server 101 is referred to as “authentication and authorization server 101”, and the server 102 is referred to as “authentication and authorization server 102”. The server 103 (region server) is referred to as “resource server 103”, and the server 104 (region server) is referred to as “resource server 104”. The server 105 (management server) is referred to as “connection management server 105”, and the server 106 is referred to as “subscription management server 106”. In addition, the expression “authentication and authorization servers 101 and 102” is used in a case where either the authentication and authorization server 101 or the authentication and authorization server 102 is applicable, and the expression “resource servers 103 and 104” is used in a case where either the resource server 103 or the resource server 104 is applicable.

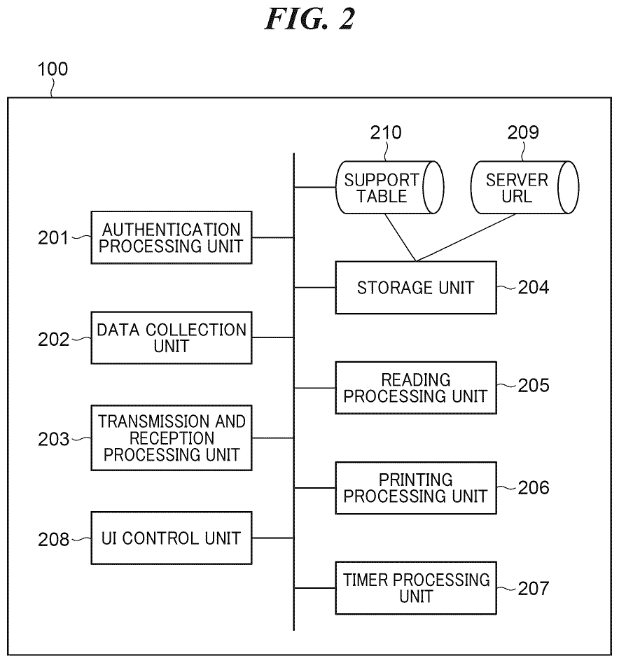

FIG. 2 is a diagram showing a software configuration of the MFP 100 according to the first embodiment. Each functional unit shown in FIG. 2 is implemented by the CPU 111 included in the MFP 100 executing a control program. An authentication processing unit 201 controls the communication unit I/F 118 to perform communication with the authentication and authorization servers 101 and 102 and the like via the network. A data collection unit 202 collects internal data in the MFP 100. The transmission and reception processing unit 203 controls the communication unit I/F 118 to control connection, disconnection, and communication with the network, and transmits the data collected by the data collection unit 202 to the resource servers 103 and 104. Furthermore, the transmission and reception processing unit 203 controls the communication unit I/F 118 to perform communication with the connection management server 105 and the like via the network.

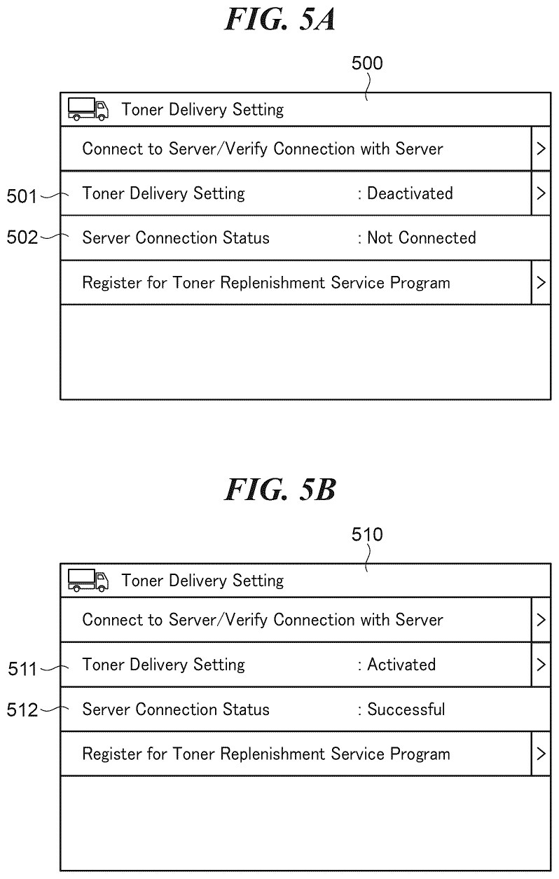

A user interface (UI) control unit 208 controls the operation unit 119 via the operation unit I/F 115. Specifically, the UI control unit 208 displays a user notification, options, and the like on the operation unit 119, receives an operation on the operation unit 119 by the user, and notifies the other functional units of an operation content. Furthermore, in the first embodiment, the UI control unit 208 performs control by receiving a user operation as in FIGS. 5A and 5B (device registration in an automatic ordering service for consumables). A storage unit 204 stores designated data in the ROM 112, the RAM 113, or the storage 114 or reads the stored data according to an instruction from another functional unit. Further, in the first embodiment, the storage unit 204 refers to a server URL 209 for a connection destination and a support table 210 for the automatic ordering service for consumables, the server URL 209 and the support table 210 being stored in the storage 114 of the MFP 100.

A reading processing unit 205 sends various predetermined commands to the reading unit 120 via the reading unit I/F 116 and receives a state of the reading unit 120 to control an operation of the reading unit 120. A printing processing unit 206 sends various predetermined commands to the printing unit 121 via the printing unit I/F 117 and receives a state of the printing unit 121 to control an operation of the printing unit 121. When time counting processing is executed by the CPU 111, a timer processing unit 207 determines whether or not a predetermined time has elapsed.

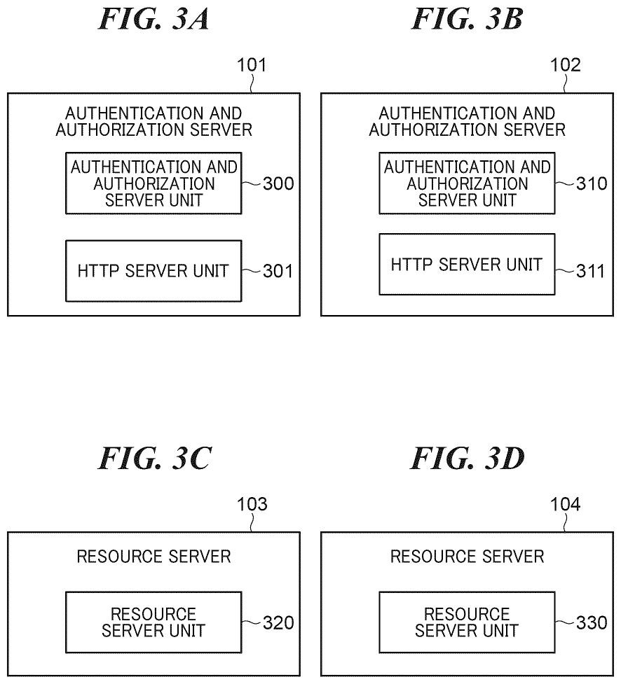

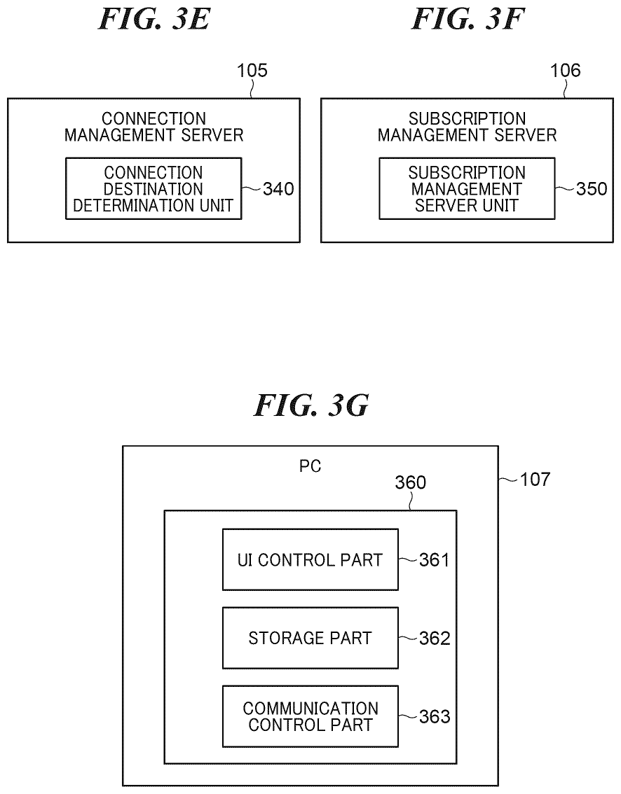

FIGS. 3A to 3G are diagrams showing software configurations of the authentication and authorization server 101, the authentication and authorization server 102, the resource server 103, the resource server 104, the connection management server 105, the subscription management server 106, and the PC 107 in the first embodiment. As shown in FIGS. 3A and 3B, the authentication and authorization server 102 has a function similar to that of the authentication and authorization server 101. As shown in FIGS. 3C and 3D, the resource server 104 has a function similar to that of the resource server 103. Therefore, in the description of FIGS. 3A, 3B, 3C, and 3D, the authentication and authorization server 101 of FIG. 3A and the resource server 103 of FIG. 3C will be described as examples.

As shown in FIG. 3A, the authentication and authorization server 101 includes an authentication and authorization server unit 300 and an HTTP server unit 301. The HTTP server unit 301 is connected to the MFP 100 via a network of a wide-area network, and performs HTTP communication with the communication unit I/F 118 of the MFP 100. Furthermore, the HTTP server unit 301 can perform communication by secure socket layer/transport layer security (SSL/TLS), and includes a certificate store (not shown). The authentication and authorization server unit 300 receives a request from the communication unit I/F 118 of the MFP 100 via the HTTP server unit 301, and transmits, as a response, a result for the received request.

Specifically, the authentication and authorization server unit 300 receives a request for device authentication from the communication unit I/F 118 of the MFP 100 via the HTTP server unit 301. Further, the authentication and authorization server unit 300 generates an authentication token associated with device identification information of the device for which the authentication has succeeded, and notifies the communication unit I/F 118 of the MFP 100 of the generated authentication token. The authentication token is a token for indicating that the device has logged in to the authentication and authorization server 101, or a token for verifying whether or not the device has been authenticated in the authentication and authorization server 101. The authentication and authorization server 101 can identify the device by using the authentication token (hereinafter, referred to as “access token”). The authentication and authorization server 101 can also be configured to hold a secret key for assigning signature information to the authorization token. In this case, the authentication and authorization server 101 assigns the signature information to the authorization token by using the secret key, and issues the authorization token with the signature information to the MFP 100.

As shown in FIG. 3C, the resource server 103 includes a resource server unit 320. The resource server unit 320 is a function of disclosing an API for providing a web service. As shown in FIG. 3E, the connection management server 105 includes a connection destination determination unit 340. The connection destination determination unit 340 is a function of receiving a request from the communication unit I/F 118 of the MFP 100 and transmitting, as a response, a URL of an endpoint of a connection destination as a result for the received request. As shown in FIG. 3F, the subscription management server 106 includes a subscription management server unit 350. The subscription management server unit 350 manages subscription information for the automatic ordering service for consumables from the user. The subscription management server unit 350 notifies the resource servers 103 and 104 of the subscription information of the user. It should be noted that, similarly to the authentication and authorization server 101, each of the resource servers 103 and 104, the connection management server 105, and the subscription management server 106 may include an HTTP server unit and perform reception and transmission with the outside via the HTTP server unit.

As shown in FIG. 3G, a printer application 360 is arranged in the PC 107. Since the printer application 360 is included in an integrated installer for installing the printer application 360, the printer application 360 itself recognizes supported printers. The printer application 360 includes a UI control part 361, a storage part 362, and a communication control part 363. The UI control part 361 of the printer application 360 displays various status screens related to the printer, a notification to the user, a printing result, and the like, and receives an operation or an instruction from the user on the displayed screen.

The communication control part 363 connects the PC 107 to the network and performs communication with a device on the network. Furthermore, the communication control part 363 performs periodical polling for the printer supported by the printer application 360. The storage part 362 stores consumables information including a remaining amount of consumables acquired from the printer and URL information of a consumables purchase site in the HDD 135, and updates the consumables information when there is existing information. In the first embodiment, the printer application 360 supports the MFP 100. It should be noted that, although software of the PC 107 has components that are not shown, the components are known technologies existing according to related arts, and thus a detailed description thereof is omitted.

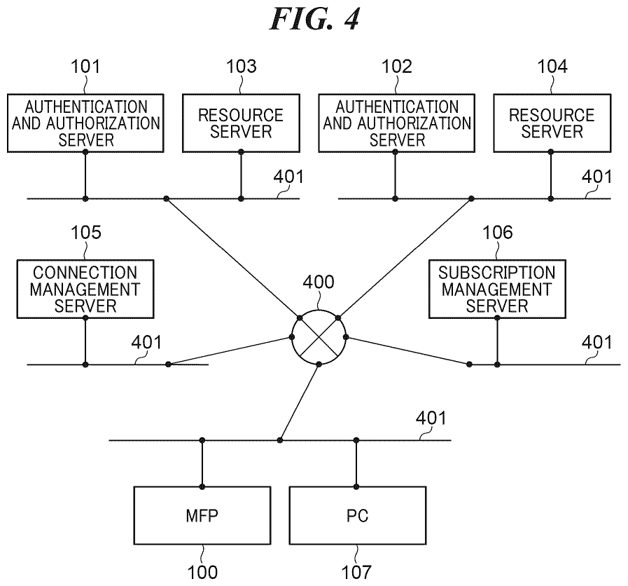

FIG. 4 is a diagram showing a network configuration of the system according to the first embodiment. The network configuration of the system will be described below. A wide area network (WAN) 400 is constructed by a world wide web (WWW) system. The WAN 400 is connected to the MFP 100 via a local area network (LAN) 401. Further, the WAN 400 is connected to the authentication and authorization server 101, the authentication and authorization server 102, the resource server 103, the resource server 104, the connection management server 105, the subscription management server 106, and the PC 107 via the LAN 401.

The authentication and authorization servers 101 and 102 are servers for implementing Open Authorization 2.0 (OAuth 2.0), and execute processing such as reception of an authentication request or issuance and management of an authorization code. In FIG. 4, the authentication and authorization server 101 and the resource server 103 are connected by the LAN 401. However, the authentication and authorization server 101 and the resource server 103 may also be connected via the WAN 400. The same applies to the authentication and authorization server 102 and the resource server 104. In addition, the authentication and authorization server 101 may be connected to a database server (not shown) via the LAN 401, and may be configured to store data used for implementing the function of the authentication and authorization server 101 itself in the database server. The same applies to the authentication and authorization server 102. Furthermore, in FIG. 4, the authentication and authorization server 101 and the resource server 103 are separate servers, but the functions of both servers may be implemented on the same server. The same applies to the authentication and authorization server 102 and the resource server 104.

The authentication and authorization server 101 and the authentication and authorization server 102 are servers arranged in different regions, and do not exchange information with each other. The same applies to the resource server 103 and the resource server 104. However, a form in which the authentication and authorization server 101 and the resource server 103 are present is not limited to a form in which the authentication and authorization server 101 and the resource server 103 are present in the same region or in the same system. Any form may be used as long as the resource server 103 can query an authentication and authorization token issued by the authentication and authorization server 101. Alternatively, the resource server 103 may verify the signature information received together with the authentication and authorization token. The same applies to the authentication and authorization server 102 and the resource server 104.

The connection management server 105 is a server that manages the endpoint, and manages the endpoints of the authentication and authorization servers 101 and 102 and the resource servers 103 and 104. It should be noted that the connection management server 105 may be configured to be connected to the database server (not shown) via the LAN 401 and store the data of the endpoint in the database server. The subscription management server 106 is a server that manages the automatic ordering service for consumables, and performs automatic ordering of consumables upon receiving an ordering trigger from the resource servers 103 and 104.

In the first embodiment, a configuration in which one subscription management server 106 corresponds to two resource servers 103 and 104 is described, but two separate subscription management servers may correspond to the two resource servers 103 and 104. The MFP 100 acquires the URL of the endpoint from the connection management server 105, requests authentication to the authentication and authorization servers 101 and 102, and transmits the consumables information to the resource servers 103 and 104 via the LAN 401. The PC 107 acquires the consumables information from the MFP 100 via the LAN 401, and acquires the access token for accessing the resource servers 103 and 104.

FIGS. 5A and 5B are views showing an example of a screen for device registration. The screens shown in FIGS. 5A and 5B are setting screens for transmitting the consumables information of the MFP 100 to the resource server 103 in order for the user to use the automatic ordering service for consumables. When the user activates a toner delivery function, the device registration in the resource server 103 is performed. A toner delivery setting screen 500 in FIG. 5A is a screen for the user to set toner delivery. The toner delivery setting screen 500 is displayed on the operation unit 119 in the MFP 100 and is controlled by the UI control unit 208. The user can change a toner delivery setting by selecting toner delivery setting 501.

On the toner delivery setting screen 500, the toner delivery setting 501 indicates “Deactivated”, and server connection status 502 indicates “Not Connected”. On a toner delivery setting screen 510 of FIG. 5B, toner delivery setting 511 indicates “Activated”, and server connection status 512 indicates “Successful”. It should be noted that even when the toner delivery setting 511 is “Activated”, the server connection status 512 may indicate “Not Connected” in a case where communication for the device registration has failed. Hereinafter, “Activated” of the toner delivery setting 511 is referred to as “on”, and “Deactivated” of the toner delivery setting 511 is referred to as “off”.

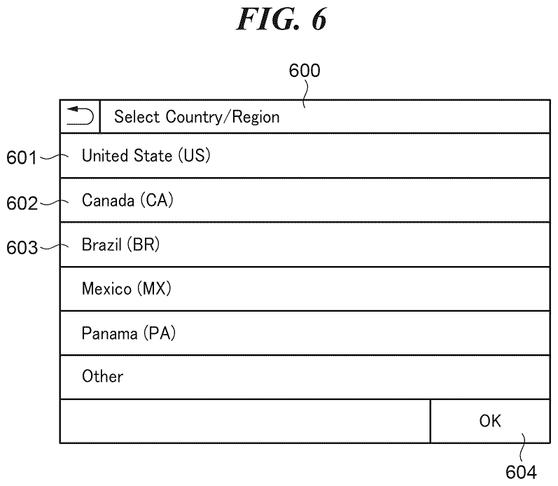

FIG. 6 is a view showing an example of a region setting screen. A region setting screen 600 is a screen for the user to set the region of the MFP 100. The region setting screen 600 is displayed on the operation unit 119 in the MFP 100 and is controlled by the UI control unit 208. Regions such as United State (US) 601, Canada (CA) 602, and Brazil (BR) 603 can be selected on the region setting screen 600. It should be noted that Reference Numeral 604 indicates an OK button. In the first embodiment, a list of settable regions is managed by the ROM 112 or the storage 114. However, the list may also be acquired from an external server. Furthermore, the regions selectable on the region setting screen 600 do not have to be fixed. For example, the selectable regions may be limited by a model type corresponding to a region (destination group) in which the MFP 100 is sold.

A change of a region setting made on the region setting screen 600 affects not only the endpoint of the authentication and authorization server or the resource server accessed by the MFP 100 but also a default setting of a transmission/reception function of a facsimile. The change of the region setting made on the region setting screen 600 also affects a default paper size setting of a sheet feeding tray cassette in the printing function and an image adjustment mode in an adjustment/maintenance function. Specifically, the image adjustment mode corresponding to a characteristic of paper used in each country or each region is set. It should be noted that the present technology is not limited to the above, and network and security settings may be switched according to the change of the region setting.

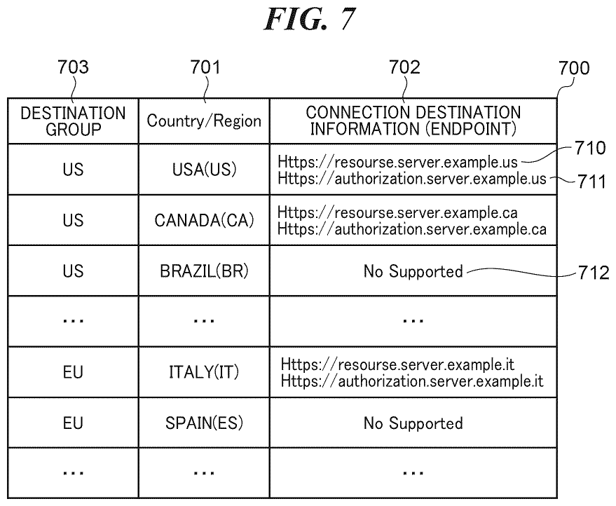

FIG. 7 is a diagram for describing a relationship between the region and the endpoint. An endpoint management table 700 is managed by the HDD 135 of the connection management server 105. Country/Region 701 represents a type of the region, and connection destination information (endpoint) 702 represents the URL or the like of the endpoint of the server corresponding to Country/Region 701. Destination group 703 represents destination information that classifies the region in which the MFP 100 is sold. For example, the regions such as USA (US), CANADA (CA), and BRAZIL (BR) are associated with a US group. In connection destination information (endpoint) 702, for example, a resource server URL 710 is the URL of the endpoint of the resource server in a case where the Country/Region 701 is USA (US). Similarly, an authentication and authorization server URL 711 is the URL of the endpoint of the authentication and authorization server in a case where the Country/Region 701 is USA (US). In a case where the Country/Region 701 is BRAZIL (BR), non-support information 712 is information indicating that the automatic ordering service for consumables is not supported.

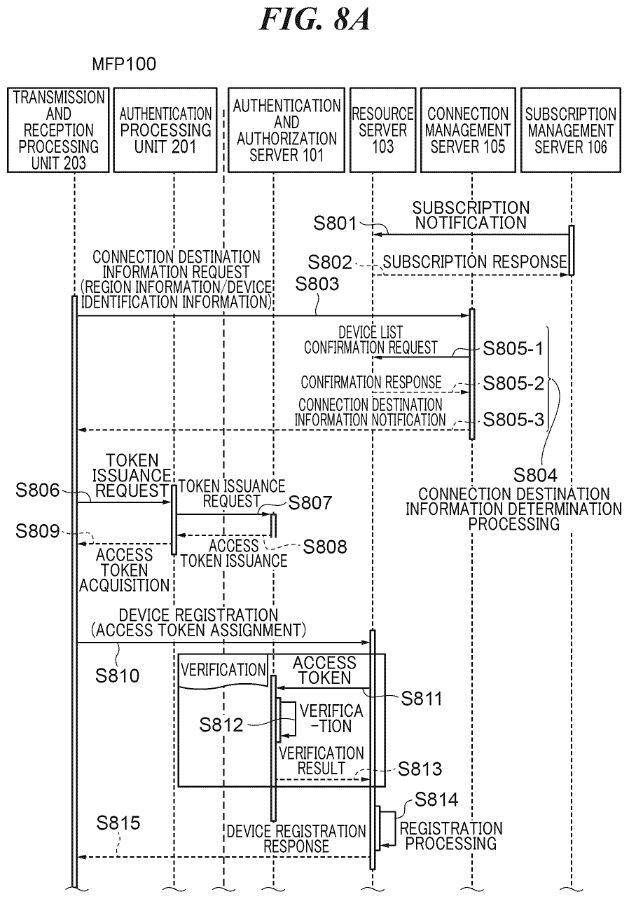

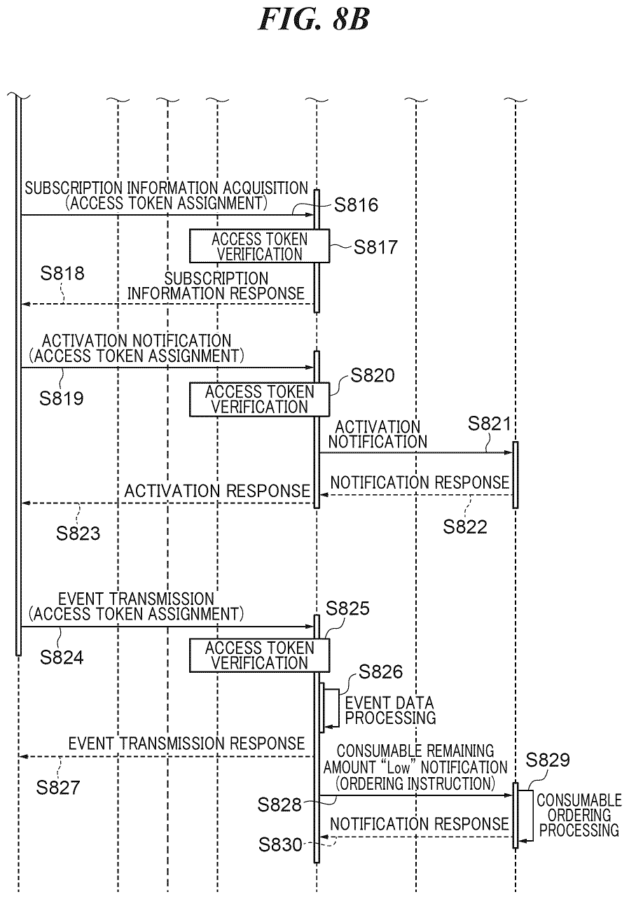

FIGS. 8A and 8B are diagrams showing communication sequences among the MFP 100, the authentication and authorization server 101, the resource server 103, the connection management server 105, and the subscription management server 106. Hereinafter, processing from device registration including connection information acquisition to consumables information transmission will be described. Each operation (control method for device) of the MFP 100 shown in the sequences of FIGS. 8A and 8B is implemented by the CPU 111 (computer) reading a control program (program) stored in the ROM 112 or the storage 114 into the RAM 113 and executing the control program. In addition, each operation of the authentication and authorization server 101 shown in the sequences of FIGS. 8A and 8B is implemented by the CPU 131 reading a control program stored in the ROM 132 or the HDD 135 into the RAM 133 and executing the control program. The same applies to each operation of each of the resource server 103, the connection management server 105, and the subscription management server 106.

First, in step S801, the subscription management server 106 makes a subscription notification (subscription notification) to the resource server 103. The subscription notification indicates that the user has subscribed to a contract for the automatic ordering service (service) for consumables via a web browser of an information processing apparatus (for example, a PC, a tablet terminal, or a smartphone) that is not shown. When the subscription notification is made, the subscription information is managed in the resource server 103. The subscription information includes the identification information of the device capable of identifying for which device the subscription has been made. In step S802, the resource server 103 returns a subscription response to the subscription management server 106.

In the MFP 100, in a case where the user turns on the toner delivery setting 501 on the toner delivery setting screen 500 displayed by the UI control unit 208 (in a case where the setting of the service is turned on), the detection by the CPU 111 triggers the start of step S803. Therefore, in the sequences of FIGS. 8A and 8B, the subscription notification in step S801 and the subscription response in step S802 are made before the toner delivery setting 501 is turned on. In step S803, the transmission and reception processing unit 203 transmits a connection destination information request (information request) to the connection management server 105 (transmission step). At this time, the transmission and reception processing unit 203 assigns the device identification information (identification information) of the MFP 100 and the region information including the region set on the region setting screen 600 to the connection destination information request. It should be noted that the destination information described above may be assigned to the connection destination information request. In step S804, the connection management server 105 executes connection destination information determination processing. The connection destination information determination processing in step S804 includes processing in steps S805-1, S805-2, and S805-3.

In step S805-1, the connection management server 105 transmits a device list confirmation request to the resource server 103. In step S805-2, the resource server 103 returns a confirmation response to the connection management server 105. Specifically, the connection management server 105 passes the device identification information transmitted from the transmission and reception processing unit 203 of the MFP 100 in step S803 to the resource server 103 as a search key. The resource server 103 performs searching to confirm whether or not the device identification information corresponding to the device identification information passed from the connection management server 105 exists in the subscription information managed by the resource server 103 itself.

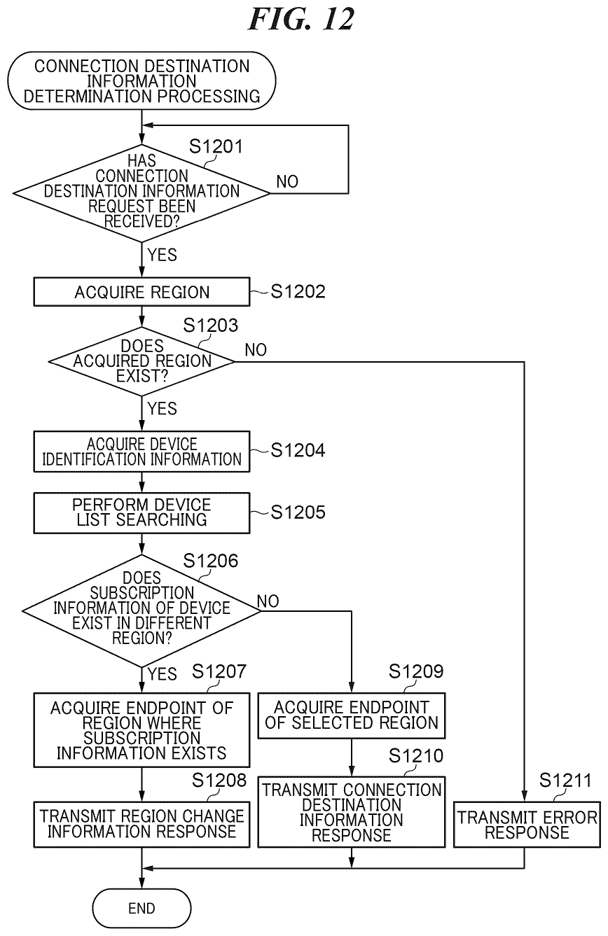

It should be noted that, in the first embodiment, the device identification information is searched for in the resource server 103 as described above, but the connection management server 105 may acquire the subscription information from the resource server 103 and search for the device identification information. In step S805-3, the connection management server 105 returns a connection destination information notification (search information) including a result of the search for the device identification information to the transmission and reception processing unit 203 of the MFP 100 as a response to the connection destination information request (reception step). In this manner, the connection destination information determination processing in step S804 is executed, and a detailed description thereof will also be made with reference to the flowchart in FIG. 12 described below.

It should be noted that, in the first embodiment, as information regarding the endpoint corresponding to the region set in the MFP 100, the connection management server 105 notifies the MFP 100 of information regarding the endpoints of the authentication and authorization server 101 and the resource server 103. However, depending on the set region, the information regarding the endpoints of the authentication and authorization server 102 and the resource server 104 is notified as the information regarding the corresponding endpoint. Further, in the MFP 100, the storage unit 204 stores, in the server URL 209, the information regarding the endpoint acquired by the connection destination information notification from the connection management server 105.

In step S806, the transmission and reception processing unit 203 transmits a token issuance request to the authentication processing unit 201. In step S807, the authentication processing unit 201 transmits the token issuance request to the authentication and authorization server 101 together with authentication information (not shown). In step S808, the authentication and authorization server 101 executes processing of issuing the access token and returns the issued access token as a response to the authentication processing unit 201 of the MFP 100. As a result, the authentication processing unit 201 acquires the access token. In step S809, the authentication processing unit 201 transmits the acquired access token to the transmission and reception processing unit 203.

In step S810, the transmission and reception processing unit 203 requests the resource server 103 to perform the device registration by using the acquired access token. In step S811, the resource server 103 requests the authentication and authorization server 101 to verify whether or not the access token received from the transmission and reception processing unit 203 of the MFP 100 is valid. In step S812, the authentication and authorization server 101 verifies whether or not the access token received from the resource server 103 is valid. In step S813, the authentication and authorization server 101 transmits a verification result in step S812 to the resource server 103.

In step S814, if the verification result in step S812 indicates that the access token is valid, the resource server 103 executes registration processing for providing the service. In step S815, the resource server 103 returns a processing result in step S814 to the transmission and reception processing unit 203 of the MFP 100 as a device registration response. However, if the verification result in step S812 indicates that the access token is invalid, the resource server 103 does not execute the registration processing in step S814, and returns an error to the transmission and reception processing unit 203 of the MFP 100 in step S815. It should be noted that the authentication and authorization server 101 issues and verifies the access token according to the OAuth 2.0 method as described above. However, the verification of the access token is not limited to the verification using the OAuth 2.0 method, and may be Basic verification or verification using a password.

In step S816, the transmission and reception processing unit 203 requests the resource server 103 to acquire the subscription information by using the acquired access token. In step S817, the resource server 103 and the authentication and authorization server 101 execute processing of each of steps S811 to S813. In step S818, if the verification result in step S817 indicates that the access token is valid, the resource server 103 returns a request information acquisition response to the transmission and reception processing unit 203 of the MFP 100.

It should be noted that, in the sequences of FIGS. 8A and 8B, the resource server 103 has received the subscription notification in step S801, and thus, the resource server 103 returns a response indicating that “subscription has been made” to the transmission and reception processing unit 203 of the MFP 100 in step S818. However, if the processing in step S801 has not been executed, that is, if the user has not subscribed to the automatic ordering service for consumables, the resource server 103 returns a response indicating that “no subscription has been made” to the transmission and reception processing unit 203 of the MFP 100 in step S818.

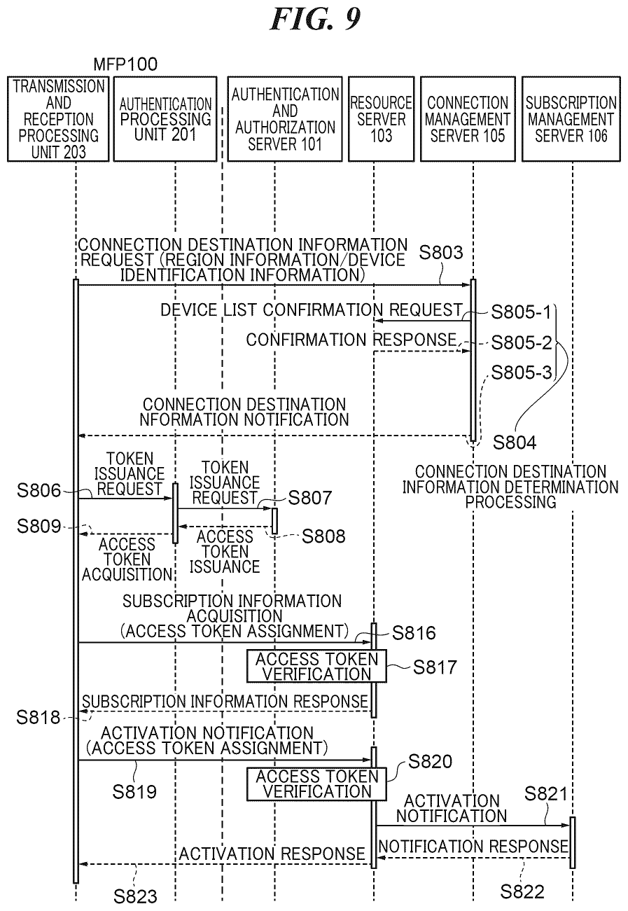

In step S819, the transmission and reception processing unit 203 transmits an activation notification indicating that the toner delivery setting 501 is turned on to the resource server 103 by using the acquired access token. However, in a case where the response indicating that “no subscription has been made” is returned in step S818, the transmission and reception processing unit 203 does not make the activation notification in step S819, and the timer processing unit 207 performs timer counting. Then, the transmission and reception processing unit 203 executes a periodic acquisition sequence shown in FIG. 9 described below after the lapse of a predetermined time. As a result, the sequences of FIGS. 8A and 8B can correspond to a case where the subscription notification in step S801 and the subscription response in step S802 are made after the toner delivery setting 501 is turned on. In step S820, the resource server 103 and the authentication and authorization server 101 execute processing of each of steps S811 to S813. In step S821, if the verification result in step S820 indicates that the access token is valid, the resource server 103 transmits the activation notification to the subscription management server 106. In step S822, the subscription management server 106 returns a notification response to the resource server 103. In step S823, the resource server 103 returns an activation response to the transmission and reception processing unit 203 of the MFP 100.

In step S824, the transmission and reception processing unit 203 performs event transmission to the resource server 103 by using the acquired access token. The event transmission means that the consumables information is transmitted in a case where a status of the consumable in the MFP 100 has changed. It should be noted that examples of the case where the status of the consumable inside the MFP 100 has changed include a case where a remaining amount of the consumable has decreased and a case where the consumable has been replaced. In addition, the event transmission may be performed at a timing when the MFP 100 is activated or at a regular timing. In step S825, the resource server 103 and the authentication and authorization server 101 execute processing of each of steps S811 to S813.

In step S826, if the verification result in step S825 indicates that the access token is valid, the resource server 103 executes event data processing. Specifically, in the event data processing, the resource server 103 analyzes the consumables information transmitted from the transmission and reception processing unit 203 of the MFP 100 and extracts information regarding the remaining amount of the consumable to confirm a state of the remaining amount. In step S827, the resource server 103 returns, as an event transmission response, a result of event reception to the transmission and reception processing unit 203 of the MFP 100. In step S828, in a case where it is determined that the remaining amount of the consumable is below a predetermined threshold based on a result of the event data processing in step S826, the resource server 103 transmits a consumable remaining amount “Low” notification (ordering instruction) to the subscription management server 106. In step S829, the subscription management server 106 executes consumable ordering processing. By executing the consumable ordering processing in this manner, the consumable is delivered to the user. In step S830, the subscription management server 106 returns a notification response to the resource server 103.

FIG. 9 is a diagram showing the periodic acquisition sequence. As described above, a timing at which the periodic acquisition sequence in FIG. 9 is executed is after the lapse of a predetermined time from when the response indicating that “no subscription has been made” is returned in step S818. In addition, the periodic acquisition sequence of FIG. 9 may be executed at a timing when the MFP 100 is activated or at a regular timing. It should be noted that each processing in the periodic acquisition sequence of FIG. 9 is similar to the sequences of FIGS. 8A and 8B, and thus a description thereof is omitted.

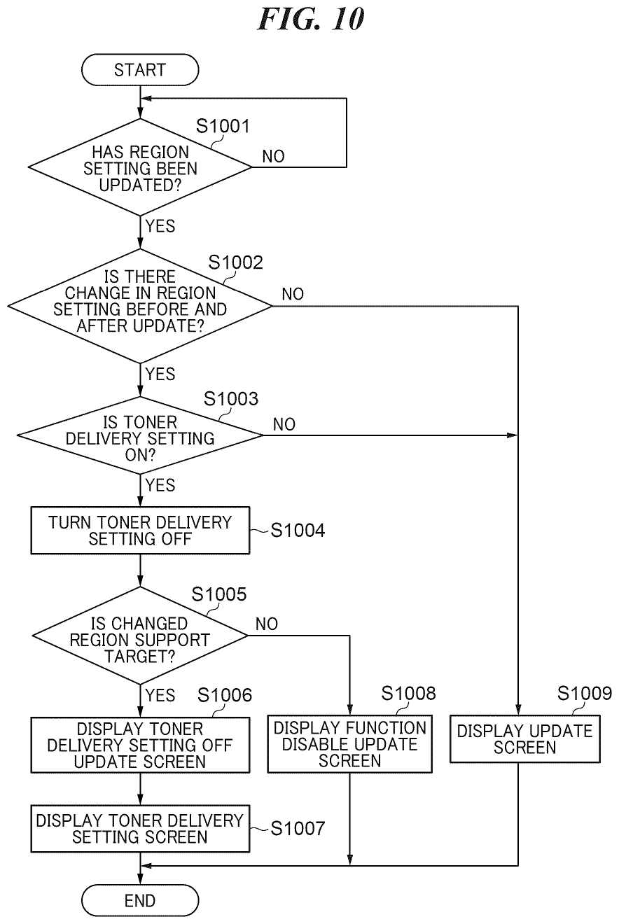

FIG. 10 is a flowchart in a case where the region setting has been changed on the region setting screen 600. In the MFP 100, the CPU 111 reads a control program stored in the ROM 112 or the storage 114 into the RAM 113 and executes the control program to implement each operation shown in the flowchart of FIG. 10. First, in step S1001, the UI control unit 208 determines whether or not the region setting has been updated. Specifically, the UI control unit 208 determines that the region setting has been updated when the OK button 604 is pressed after the region such as the United State (US) 601 is selected on the region setting screen 600. In a case where the UI control unit 208 determines that the region setting has not been updated, the processing returns to step 1001. On the other hand, in a case where the UI control unit 208 determines that the region setting has been updated, the processing proceeds to step 1002.

In step S1002, the storage unit 204 determines whether or not there is a change in the region setting before and after the update. In a case where the storage unit 204 determines that there is no change in the region setting before and after the update, the processing proceeds to step S1009 described below. On the other hand, in a case where the storage unit 204 determines that there is a change in the region setting before and after the update, the processing proceeds to step S1003. In step S1003, the storage unit 204 determines whether or not the toner delivery setting 501 is on. It should be noted that, when the toner delivery setting 501 is in an on state, the device registration is successful in the resource server 103. In a case where the storage unit 204 determines that the toner delivery setting 501 is not on, the processing proceeds to step S1009 described below. On the other hand, in a case where the storage unit 204 determines that the toner delivery setting 501 is on, the processing proceeds to step S1004. In step S1004, the storage unit 204 updates the toner delivery setting 501 to off in response to the change of the region setting in order to prevent data transmission to a region different from the changed region.

In step S1005, the storage unit 204 determines whether or not the changed region is a support target of the automatic ordering service for consumables. The determination as to whether or not the region is a support target is made by comparing the support table 210 indicating target regions of the automatic ordering service for consumables read by the CPU 111 in the storage unit 204 with the region set on the region setting screen 600. It should be noted that, in the first embodiment, the support table 210 is managed inside the MFP 100, but the support table 210 may also be acquired from an external server. In a case where the storage unit 204 determines that the changed region is a support target of the automatic ordering service for consumables, the processing proceeds to step S1006. On the other hand, in a case where the storage unit 204 determines that the changed region is not a support target of the automatic ordering service for consumables, the processing proceeds to step S1008 described below.

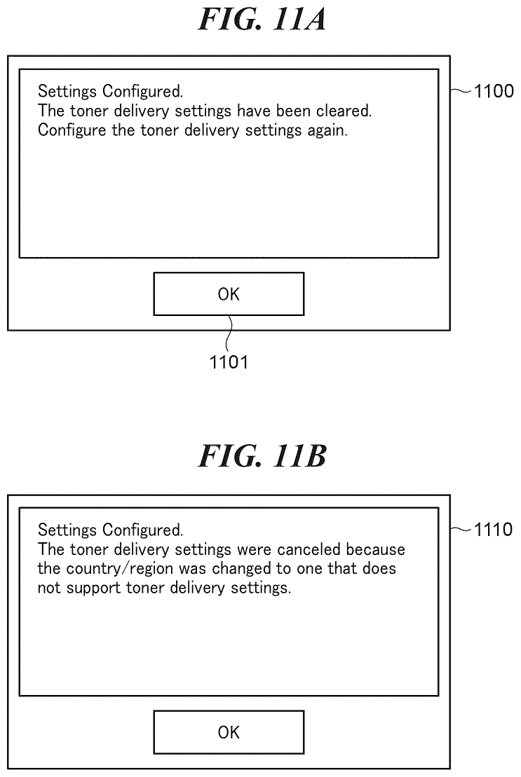

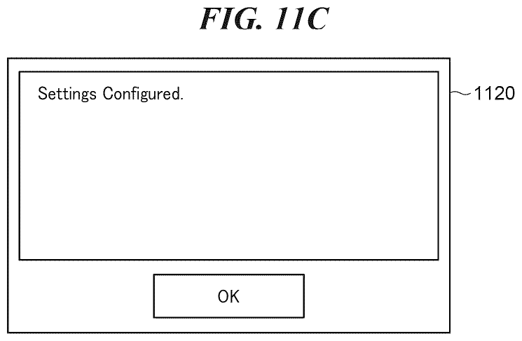

In step S1006, the UI control unit 208 displays a toner delivery setting off update screen 1100 of FIG. 11A on the operation unit 119. In step S1007, when the user selects an OK button 1101 on the toner delivery setting off update screen 1100 in FIG. 11A, the UI control unit 208 displays the toner delivery setting screen 500 on the operation unit 119. It should be noted that, in the first embodiment, the toner delivery setting screen 500 is displayed. However, alternatively, a notification of automatic re-connection may be made and re-registration processing may be executed. In step S1008, the UI control unit 208 displays a function disable update screen 1110 in FIG. 11B on the operation unit 119. In step S1009, the UI control unit 208 displays an update screen 1120 of FIG. 11C. When processing of any one of steps S1007 to S1009 is executed, the flowchart of FIG. 10 ends.

FIG. 12 is a flowchart of the connection destination information determination processing. In the connection management server 105, the CPU 131 reads a control program stored in the ROM 132 into the RAM 133 and executes the control program to implement each operation shown in the flowchart of FIG. 12. The same applies to the resource servers 103 and 104. The flowchart of FIG. 12 illustrates the processing in step S804 of FIG. 8A. It should be noted that, here, a description will be given on the assumption that the United State (US) 601 is set as the region on the region setting screen 600. First, in step S1201, the connection destination determination unit 340 determines whether or not the connection destination information request has been received from the transmission and reception processing unit 203 of the MFP 100. In a case where the connection destination determination unit 340 determines that the connection destination information request has not been received from the transmission and reception processing unit 203 of the MFP 100, the processing returns to step S1201. On the other hand, in a case where the connection destination determination unit 340 determines that the connection destination information request has been received from the transmission and reception processing unit 203 of the MFP 100, the processing proceeds to step S1202. In step S1202, the connection destination determination unit 340 acquires the region (US) included in the region information assigned to the connection destination information request.

In step S1203, the connection destination determination unit 340 reads the endpoint management table 700 managed by the HDD 135 of the connection management server 105. Further, the connection destination determination unit 340 determines whether or not the region (US) acquired in step S1202 exists in the Country/Region 701 of the endpoint management table 700. In a case where the connection destination determination unit 340 determines that the region (US) acquired in step S1202 exists in the Country/Region 701 of the endpoint management table 700, the processing proceeds to step S1204. On the other hand, in a case where the connection destination determination unit 340 determines that the region (US) acquired in step S1202 does not exist in the Country/Region 701 of the endpoint management table 700, the processing proceeds to step S1211 described below.

In step S1204, the connection destination determination unit 340 acquires the device identification information assigned to the connection destination information request. In step S1205, the connection destination determination unit 340 performs device list searching. The connection destination determination unit 340 performs the device list searching by transmitting the device list confirmation request to which the device identification information acquired in step S1204 is assigned to the resource server 103. Here, as an example, it is assumed that the resource server 103 is arranged in USA (US) and the resource server 104 is arranged in CANADA (CA). In addition, it is assumed that the device identification information is a serial number that can uniquely identify the MFP.

Upon receiving the device list confirmation request, the resource server 103 performs searching for the subscription information stored in the HDD 135 of the resource server 103. At this time, the resource server 103 performs searching by using the serial number of the device identification information assigned to the device list confirmation request, and transmits a search result as the confirmation response to the connection destination determination unit 340 of the connection management server 105. Further, after receiving the confirmation response from the resource server 103, the connection destination determination unit 340 also transmits a similar device list confirmation request to the resource server 104.

It should be noted that, in the first embodiment, there are two resource servers 103 and 104, but there may be three or more resource servers according to the number of regions. In this case, the connection destination determination unit 340 transmits the device list confirmation request to each of the three or more resource servers. When the destination information is added to the connection destination information request from the transmission and reception processing unit 203 of the MFP 100, the device list confirmation request is transmitted to the resource server arranged in each region associated with the destination information. As a result, the connection destination determination unit 340 of the connection management server 105 can limit the resource server to which the device list confirmation request is transmitted. In addition, in the first embodiment, as described above, the connection destination determination unit 340 sequentially transmits the device list confirmation requests to a plurality of resource servers. At this time, the connection destination determination unit 340 may end the transmission of the device list confirmation requests as soon as the confirmation response indicating that the serial number of the device identification information assigned to the device list confirmation request exists is received from the resource server. In addition, the connection destination determination unit 340 may transmit the device list confirmation requests to the resource servers at the same time.

In step S1206, the connection destination determination unit 340 determines whether or not the subscription information of the MFP 100 exists in the resource server 104 in a region (CANADA) different from the region (US) acquired in step S1202. The determination is made based on the confirmation responses from the resource servers 103 and 104. In a case where the connection destination determination unit 340 determines that subscription information of the MFP 100 exists in the resource server 104 in a region (CANADA) different from the region (US) acquired in step S1202, the processing proceeds to step S1207. On the other hand, in a case where the connection destination determination unit 340 determines that the subscription information of the MFP 100 does not exist in the resource server 104 in a region (CANADA) different from the region (US) acquired in step S1202, the processing proceeds to step S1209 described below.

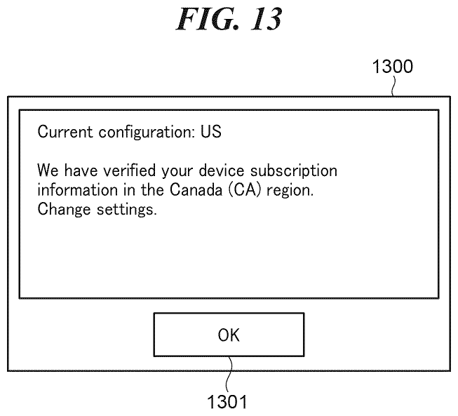

In step S1207, the connection destination determination unit 340 acquires the URL of the endpoint of the region (CANADA) where the subscription information of the MFP 100 exists based on the connection destination information (endpoint) 702 of the endpoint management table 700. In step S1208, the connection destination determination unit 340 transmits the acquired URL and a region change information response indicating that the region setting is changed from US to CA as the connection destination information notification (search information) to the transmission and reception processing unit 203 of the MFP 100. It should be noted that, when the transmission and reception processing unit 203 receives the region change information response as the connection destination information notification in step S1208, the storage unit 204 of the MFP 100 changes the region setting from US to CA. As a result, in the MFP 100, the region setting becomes suitable for a status of subscription to the automatic ordering service for consumables. FIG. 13 is a view showing a change notification screen 1300 displayed on the operation unit 119 by the UI control unit 208 in a case where the transmission and reception processing unit 203 of the MFP 100 receives the region change information response as the connection destination information notification in step S1208. On the change notification screen 1300, a notification to change the region setting from US to Canada (CA) is made for the user. As a result, the user can know an error of the region set in the MFP 100. It should be noted that the change notification screen 1300 is closed when an OK button 1301 is pressed.

The description returns to FIG. 12. In step S1209, the connection destination determination unit 340 acquires the URL of the endpoint of the region (US) acquired in step S1202 based on the connection destination information (endpoint) 702 of the endpoint management table 700. In step S1210, the connection destination determination unit 340 transmits, as the connection destination information notification (search information), a connection destination information response including the URL of the endpoint of the region (US) to the transmission and reception processing unit 203 of the MFP 100. In step S1211, the connection destination determination unit 340 transmits, as the connection destination information notification (search information), an error response to the transmission and reception processing unit 203 of the MFP 100. When the processing in step S1208, the processing in step S1210, or the processing in step S1211 is executed, the flowchart of FIG. 12 ends. It should be noted that, in the MFP 100, when the transmission and reception processing unit 203 receives the connection destination information notification in step S1210 or step S1211, the UI control unit 208 displays a screen corresponding to a response content of the received connection destination information notification on the operation unit 119.

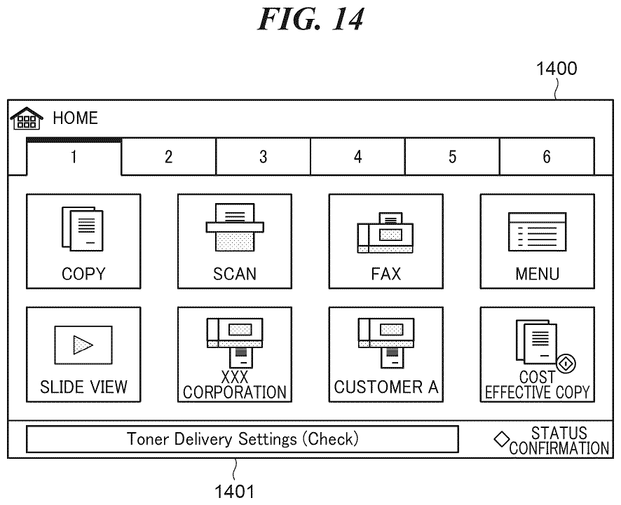

FIG. 14 is a view showing a home screen 1400 displayed on the operation unit 119 of the MFP 100 in a case where it is confirmed in step S804 that the region is different in the periodic acquisition sequence of FIG. 9. Here, a case where it is confirmed in step S804 that the region is different means a case where the subscription information of the MFP 100 is in a resource server of a region different from the region included in the region information assigned to the connection destination information request in step S803.

Since step S803 shown in the sequence of FIG. 8A is started by being triggered by the user turning on the toner delivery setting 501, it is assumed that the user is near the MFP 100. Furthermore, in the sequences of FIGS. 8A and 8B, in a case where the user turns on the toner delivery setting 501 on the toner delivery setting screen 500, when it is confirmed in step S804 that the region is different, the UI control unit 208 displays the change notification screen 1300 on the operation unit 119. However, step S803 shown in the periodic acquisition sequence of FIG. 9 is likely to be performed in a state where the user is not near the MFP 100. Therefore, in the periodic acquisition sequence of FIG. 9, in a case where it is confirmed in step S804 that the region is different, the UI control unit 208 displays a confirmation item 1401 related to the toner delivery setting 501 on the home screen 1400 displayed on the operation unit 119. It should be noted that, in the operation unit 119, when the confirmation item 1401 on the home screen 1400 is pressed, the UI control unit 208 displays the change notification screen 1300.

As described above, the MFP 100 can acquire, as a response to the connection destination information request, information regarding whether or not its own subscription information for the automatic ordering service for consumables exists in the resource servers 103 and 104 in a region different from the region of the region information. With such a response to the connection destination information request, the MFP 100 can make the region setting suitable for the status of subscription to the automatic ordering service for consumables. Therefore, the user in the first embodiment can appropriately use the automatic ordering service for consumables of the MFP 100.

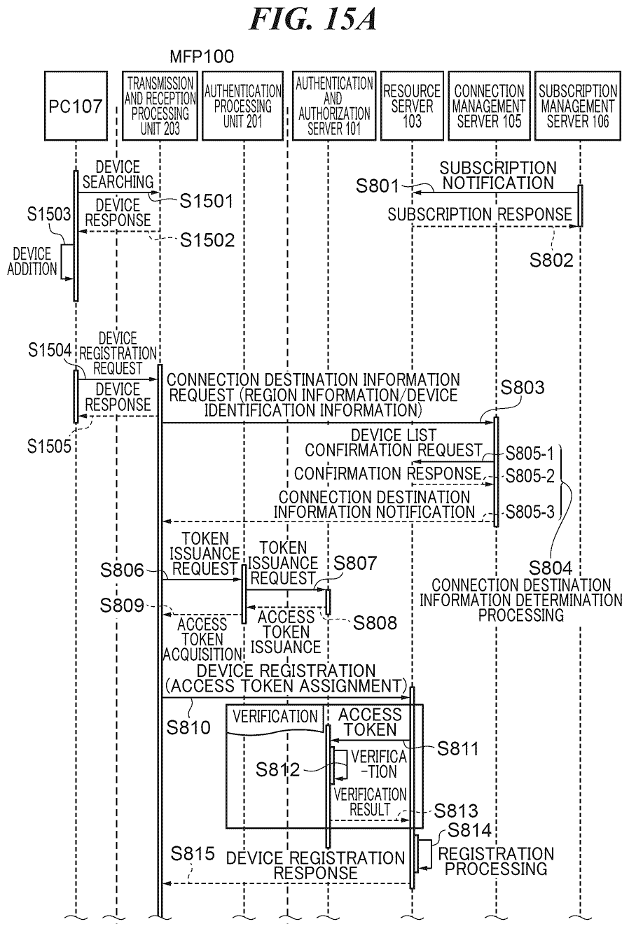

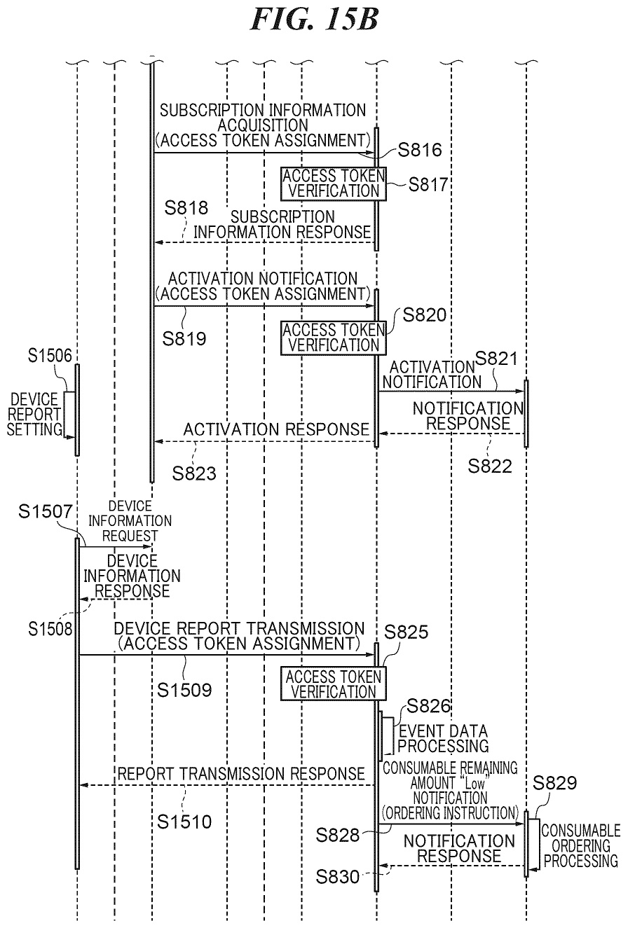

The second embodiment will be described below with reference to FIGS. 15A to 17. In the second embodiment, configurations and processing common to those of the first embodiment are denoted by the same reference numerals, and a description thereof will be simplified or omitted. Therefore, points unique to the second embodiment will be mainly described below. In the first embodiment, an example in which consumables information is transmitted from the MFP 100 has been described. However, a source of the consumables information is not limited to the MFP 100. Therefore, in the second embodiment, an example in which consumables information is transmitted from a PC 107 connected to an MFP 100 via a network of a LAN 401 will be described.

FIGS. 15A and 15B are diagrams showing communication sequences among the MFP 100, an authentication and authorization server 101, a resource server 103, a connection management server 105, a subscription management server 106, and the PC 107. Hereinafter, transmission of the consumables information by the PC 107 will be described. Each operation of the PC 107 shown in the sequences of FIGS. 15A and 15B is implemented by a CPU 131 reading a control program stored in a ROM 132 or an HDD 135 into a RAM 133 and executing the control program. The same applies to each operation of the authentication and authorization server 101, the resource server 103, the connection management server 105, and the subscription management server 106. In addition, each operation (control method for device) of the MFP 100 shown in the sequences of FIGS. 15A and 15B is implemented by a CPU 111 (computer) reading a control program (program) stored in a ROM 112 or a storage 114 into a RAM 113 and executing the control program.

First, in step S1501, the PC 107 performs device searching by a communication control part 363 of a printer application 360. At this time, the communication control part 363 performs the device searching for a device connected on the network of the LAN 401 by using a known technology such as a method for transmitting a packet by broadcasting and searching for the device or a method for specifying an IP address and sending a packet. In step S1502, when a search packet is received from the PC 107, a transmission and reception processing unit 203 of the MFP 100 transmits, as a device response, device information of the MFP 100 to the PC 107. In step S1503, the PC 107 executes device addition processing by the printer application 360.

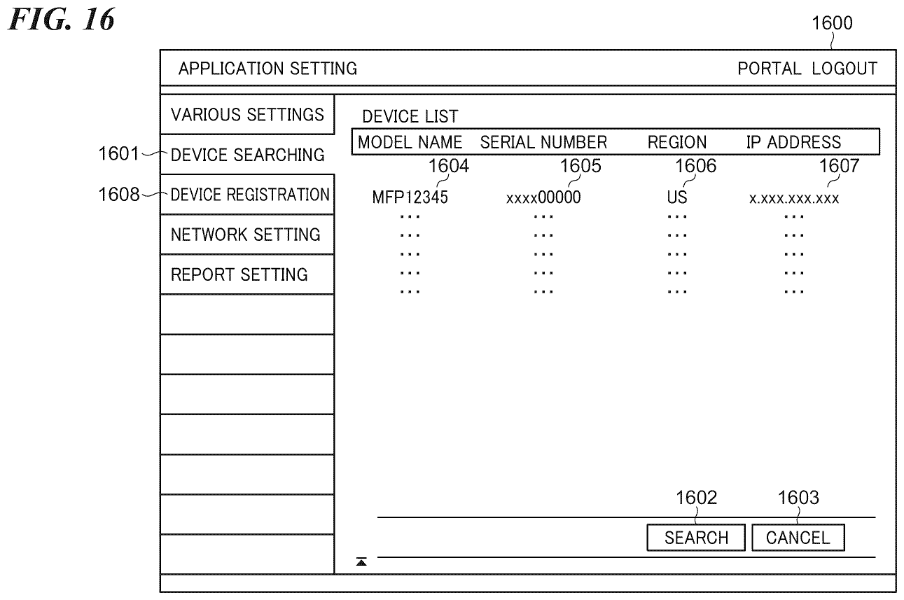

An application setting screen 1600 shown in FIG. 16 is an example of a device search screen displayed on a touch panel or the like by a UI control part 361 of the printer application 360 in the PC 107. A device list on the application setting screen 1600 is displayed when pressing a device search menu 1601 in an application setting menu. Here, when a search button 1602 is pressed, step S1501 is executed, and the device connected on the network of the LAN 401 is searched. It should be noted that the searching is canceled when a cancel button 1603 is pressed.

Furthermore, the device added in step S1503 is displayed as the device list. In the device list, the device information such as a model name 1604, a serial number 1605 as device identification information, a region 1606, and an IP address 1607 is displayed. It should be noted that the device information displayed in the device list is acquired as the device response in step S1502. It should be noted that device registration is performed when a device registration menu 1608 is pressed in the application setting menu of the application setting screen 1600.

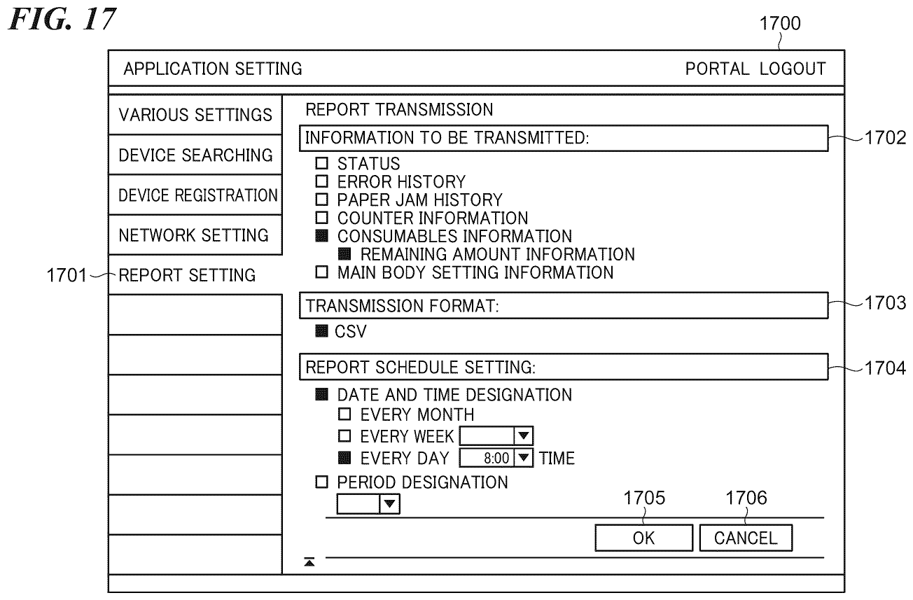

The description returns to FIG. 15A. In step S1504, the PC 107 transmits a device registration request to the transmission and reception processing unit 203 of the MFP 100 by the communication control part 363. It should be noted that the transmission is performed when the device registration menu 1608 is pressed. In this regard, step S803 of the first embodiment is started by being triggered by the user turning on the toner delivery setting 501. On the other hand, step S803 of the second embodiment is started by being triggered by the user pressing the device registration menu 1608 in step S1504. In step S1505, the transmission and reception processing unit 203 of the MFP 100 returns the device response to the PC 107. In step S1506, the PC 107 performs device report setting. The device report setting will be described below with reference to FIG. 17.

FIG. 17 is a view showing an example of a report setting screen 1700. The report setting screen 1700 shown in FIG. 17 is displayed when a report setting menu 1701 is pressed in the application setting menu shown in FIG. 16 or 17. In information 1702 to be transmitted, the user can select information to be transmitted to the resource server 103 by a check box. That is, the user can perform data transmission for information filtered by the check box by device report transmission described below. In transmission format 1703, the user can select a format of the data transmission. Here, only CSV can be selected, but XML, JSON, or the like may be made selectable.

In schedule setting 1704, the user can set a schedule for performing the device report transmission described below. It should be noted that the schedule can be set in units of time in a case of period designation, and the schedule can be set in units of months, weeks, and days in a case of date and time designation.

The setting of the schedule is determined when an OK button 1705 is pressed. In addition, the schedule in the middle of being set is canceled when a cancel button 1706 is pressed.

The description returns to FIG. 15B. The processing in step S1507 is executed at a timing of the schedule set in step S1506. In step S1507, the PC 107 transmits a device information request to the transmission and reception processing unit 203 of the MFP 100 by the communication control part 363. In step S1508, the transmission and reception processing unit 203 of the MFP 100 transmits, as a device information response, the device information to the communication control part 363 of the PC 107. It should be noted that the device information here includes, in addition to the consumables information, information regarding an access token, an endpoint acquired in a connection destination information notification, and the like. In step S1509, the PC 107 causes the communication control part 363 to transmit a device report to the resource server 103. In step S1510, the resource server 103 returns a report transmission response to the communication control part 363 of the PC 107.

As described above, even in a case where the PC 107 transmits the consumables information of the MFP 100, the PC 107 can transmit the consumables information of the MFP 100 to the resource server 103 suitable for a status of subscription to an automatic ordering service for consumables of the MFP 100. Therefore, the user in the second embodiment can also appropriately use the automatic ordering service for consumables of the MFP 100.

Although the preferred embodiments of the present invention have been described above, the present invention is not limited to the above-described embodiments, and various modifications and changes can be made within the scope of the gist of the present invention. For example, in the first embodiment and the second embodiment, the toner delivery setting screen 500 and the region setting screen 600 are implemented as independent screens, but the toner delivery setting screen 500 and the region setting screen 600 may also be implemented as the same screen. Further, the resource server 103 and the subscription management server 106 are implemented by independent servers, but the resource server 103 and the subscription management server 106 may also be implemented by the same server. The same applies to the resource server 104. The transmission of the connection destination information request in step S803 and the reception of the connection destination information notification in step S805-3 may be performed by an information processing apparatus (for example, a PC, a tablet terminal, or a smartphone) capable of performing communication with the MFP 100 and the connection management server 105. The present invention is also applicable to services other than the automatic ordering service for consumables.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009297, filed Jan. 25, 2024 which is hereby incorporated by reference wherein in its entirety.

What is claimed is:

1. A device comprising:
a transmission unit configured to transmit, to a management server, an information request to which identification information for identifying an image processing apparatus and region information including a region set in the image processing apparatus are assigned; and
a reception unit configured to receive search information from the management server as a response to the information request,
wherein the search information includes a result of searching performed using the identification information as to whether or not subscription information for a service regarding the image processing apparatus exists in a region server arranged in another region different from the region included in the region information.

2. The device according to claim 1, further comprising
a notification unit configured to make a notification according to the result of the searching included in the search information.

3. The device according to claim 1, wherein
in a case where setting of the service is turned on in the image processing apparatus, the information request is transmitted by the transmission unit.

4. The device according to claim 1, further comprising
a change unit configured to change the region set in the image processing apparatus to the another region in a case where the result of the searching indicating that the subscription information exists in the region server arranged in the another region is included in the search information.

5. The device according to claim 1, wherein
the identification information includes destination information of the image processing apparatus with which one or more regions are associated, and
the another region is a region associated with the destination information.

6. The device according to claim 1, wherein
in a case where the result of the searching indicating that the subscription information does not exist in any region server is included in the search information, the transmission unit transmits the information request to the management server after a lapse of a predetermined time from the reception of the search information by the reception unit.

7. The device according to claim 6, wherein
the transmission unit transmits the information request to the management server at a timing when the image processing apparatus is activated or at a regular timing after a lapse of a predetermined time from the reception of the search information by the reception unit.

8. The device according to claim 1, wherein
the service is an automatic ordering service for consumables.

9. The device according to claim 1, wherein
the device is the image processing apparatus.

10. The device according to claim 1, wherein
the device is an information processing apparatus configured to perform communication with the image processing apparatus and the management server.

11. A control method for device comprising:
a transmission step of transmitting, to a management server, an information request to which identification information for identifying an image processing apparatus and region information including a region set in the image processing apparatus are assigned; and
a reception step of receiving search information from the management server as a response to the information request,
wherein the search information includes a result of searching performed using the identification information as to whether or not subscription information for a service regarding the image processing apparatus exists in a region server arranged in another region different from the region included in the region information.

12. A non-transitory storage medium storing a program for causing a computer to execute a control method for device,
the control method for device including:
a transmission step of transmitting, to a management server, an information request to which identification information for identifying an image processing apparatus and region information including a region set in the image processing apparatus are assigned; and
a reception step of receiving search information from the management server as a response to the information request,
wherein the search information includes a result of searching performed using the identification information as to whether or not subscription information for a service regarding the image processing apparatus exists in a region server arranged in another region different from the region included in the region information.
